(19) United States
(12) Patent Application Publication
(10) Pub. No.: US 2014/0245116 A1
(43) Pub. Date: Aug. 28, 2014

(54) SYSTEM AND METHOD FOR CUSTOMIZED GRAPHIC DESIGN AND OUTPUT

(71) Applicant: Particle, Inc., New York, NY (US)

(72) Inventors: Nicholas E. Dangerfield, New York, NY (US); Kostadin Krajcev, Brooklyn, NY (US)

(73) Assignee: Particle, Inc., New York, NY (US)

(21) Appl. No.: 14/192,534

(22) Filed: Feb. 27, 2014

Related U.S. Application Data
(60) Provisional application No. 61/770,108, filed on Feb. 27, 2013.
(60) Provisional application No. 61/883,386, filed on Sep. 27, 2013.

(51) Int. Cl. G06F 17/24

(52) U.S. Cl. CPC G06F 17/24
USPC 715/202

(57) ABSTRACT

The present application provides a system and method for providing a digital art platform. Data structure(s) configured for storing information associated with digital art may be provided. A graphical user interface (“GUI”) operable on each of a plurality of client computing devices is provided and configured to provide a virtual canvas. A transformation module can be configured to receive at least one instruction and to modify the digital art when executed by at least one processor in response to the at least one instruction. Moreover, an update module can be included to transmit at least one instruction to at least one second of the plurality of computing devices. The modified digital art can be provided in each respective canvas of the at least one second of the plurality of computing devices in response to the at least one instruction.

### CROSS-REFERENCE TO RELATED APPLICATIONS

This application claims priority to U.S. Provisional Patent Application Ser. No. 61/770,108, filed Feb. 27, 2013, and U.S. Provisional Patent Application Ser. No. 61/883,386, filed Sep. 27, 2013, each of which is hereby expressly incorporated by reference herein.

### FIELD OF THE APPLICATION

The present relates, generally, to digital art creation and, more particularly, to a creation platform for making, using and outputting artistic objects.

### BACKGROUND OF THE INVENTION

As the world is getting more connected, individuals can distribute and receive various art. Unfortunately, the ability to create, manipulate, distribute and output art in a convenient, ubiquitous platform, however, has not been readily available.

### SUMMARY OF THE INVENTION

The present application provides a system and method for providing a digital art platform. In one or more implementations, at least one data structure configured is provided for storing, on processor readable media that is accessible using at least one processor, information associated with digital art. The information includes at least one element associated with the digital art. Moreover, a graphical user interface (“GUI”) that is operable on each of a plurality of client computing devices is provided. The GUI is configured to provide a virtual canvas, wherein the canvas is configured to provide the digital art on each of the plurality of client computing devices. A transformation module can be included that is configured to receive at least one instruction, from at least one first of the client devices operating the graphical user interface, and to modify the digital art when executed by at least one processor in response to the at least one instruction. Moreover, an update module can be included that is configured to transmit, over a data communication network, at least one instruction to at least one second of the plurality of computing devices. The modified digital art can be provided in each respective canvas of the at least one second of the plurality of computing devices in response to the at least one instruction. An output module can be provided that is configured to receive using the at least one processor, at least one output instruction from at least one of the plurality of computing devices to output the modified digital art in a physical form, and further configured to output, in response to the at least one output instruction, the modified digital art in the physical form.

These and other aspects, features, and advantages can be appreciated from the accompanying description of certain embodiments of the invention and the accompanying drawing figures and claims.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 a diagram of an example hardware arrangement that operates for providing the systems and methods disclosed herein;

FIG. 2 the functional elements of an information processor and/or workstation;

FIG. 3 is an example display screen that illustrates components associated with a Modified Object;

FIGS. 4A and 4B are example implementations illustrating how paint sticks to objects;

FIGS. 5A-5D illustrate steps associated with an example screen printing process;

FIG. 6 illustrates an example display screen in which a user has converted an image into a screenprint and has painted through it with the painting tool;

FIG. 7 illustrates an example printable surface for printing;

FIG. 8 illustrates an example use of the present application for creating creates an art object;

FIG. 9 illustrates an example implementation of the present application in which the art object that has been created is displayed in the user profile; and

FIG. 10 illustrates an example display screen for e-commerce functionality in accordance with an example implementation of the present application.

Like reference symbols in the various drawings indicate like elements.

### DETAILED DESCRIPTION OF THE INVENTION

Specific configurations and arrangements are described for illustrative purposes. A person of ordinary skill will recognize that other configurations and arrangements can be used without departing from the spirit and scope of the present application. Also, while many of the example implementations shown and described herein relate to an art platform, the invention is not so limited, and can be employed in a variety of other applications and industries.

Recently the advent of programming languages, mark-up languages and Internet-based technologies, such as HTML5, have made it possible to treat a user's web browser as a virtual multi-media canvas and display media, including for images, audio and video. The changes in technology has resulted in much improved flexibility. In some cases, HTML5 has resulted in eliminating a need for third-party plug-ins. The HTML5 standard is supported by many versions of web browser software applications, which are expected to continue to grow and develop. Used in conjunction with other browser technologies, such as JavaScript and cascading style sheets (“CSS”), HTML5 enables the building of a finite graphic interface (referred to herein, generally, as a “Field”) in which users insert, create, assemble and manipulate various content, such as text, drawings (e.g., bitmap and vector), image files, video files, embedded HTML code and audio files. In connection with the present application, any such type of files added on a Field are referred to herein, generally as “objects.” Objects may refer to virtually any digital content, such as images, video, audio content or the like, and may be configured in various formats, such as JPEG, PNG, AVI, MPG, MP3, MP4, other suitable type of files.

The details of one or more implementations are set forth in the accompanying drawings and the description below. Other features and advantages will be apparent from the description and drawings.

The present application provides a web client application that is based on standards-compliant modem web technologies that include HTML5, CSS and JavaScript(“JS”). At least some of the JS code may rely on the EMBER.JS framework and its corresponding data-managing counterpart, EMBER DATA. In one or more implementations, other vendor JS libraries are provided that may include one or more of: jQuery (DOM manipulation and AJAX events); Moment.js (friendly timestamps); Moment.js (friendly timestamps); ID3.js (parsing ID3 information); Tracekit.js (for debugging client-side code) and Pusher (for real-time messaging between clients and servers).

In one or more implementations of the present application, a web client is a “one-page” web application, where JS is used to load content from the server and render it in the client. Industry-standard AJAX and -based asynchronous approaches are used for all client-server communication.

### Field

In accordance with the present application, a “Field” represents an interactive canvas that includes a variety of content, including multi-media that may be organized in layers and viewable and capable of being manipulated in a web browser software application or other dedicated “native” application. The Field can be rendered, for example, via HTML5 and related APIs, and can be described in a JSON format. The Field may actively persist all its data on a server as new content is added or removed. Moreover, the Field may have a unique identifier and a web address, such as an IP address. Based on user permissions, one or more users can add, edit and remove content from a Field.

In one or more implementations of the present application, the basic components of a Field include: 1) Field Element(s), which may include a DOM element with a defined structure and type; 2) Stage, which may include a container of Field Elements with a defined size, and a geometric transform; 3) Viewport, which may include a container for the stage with a size that equals the browser viewport size; and 4) Tools, a collection of modules for viewing and manipulating content within the Field.

### Field Element

In one or more implementations, a FieldElement's structure and behavior may be defined by its “type,” as known in the art, and which may be deduced from a combination of children media components that it contains. These can be: image, which may correspond to an HTML <img> element; embed, . . . <iframe>; paint . . . <canvas>; audio . . . <audio>; video <video>; link, a web URL mask, a bitmap with an alpha channel or a vector shape, and HTML, a more generic block of HTML, CSS and JS with a given ‘width’ and ‘height.’

In addition to media components, a FieldElement may be included and described by one or more of the following geometric attributes: size defined by ‘width’ and ‘height’; 2D position defined by coordinates ‘x’ and ‘y’; and layer index ‘z’ scale factor ‘scale’. Some of the types a FieldElement can take on include: 1) Background; 2) Image; 3) Stencil; 4) Playlist Track; 5) Video Embed; and 6)Interactive Embed.

### Object Transformation

In accordance with the present application, an object that is placed in a Field can be transformed easily by the user. Transformation can include changing the appearance or format of an object, such as by using a paint tool to alter an image, which can be applied “on top” of the object. In another context, the object can be modified by adding sound to it, such as to enable a sound to play when a user clicks on the object. Transformations, such as sound, may be integrated in an object and may not be visible to the end-user. In yet another context, the object can be transformed by adding images to it, such that when a user selects the object (e.g., by clicking on it with a mouse), the new image appears. The object may be formatted such that the new image appears in a form of a slide show, and alternating images can also change based on an automated rotation. As used herein, an object that is modified by a user is referred to herein, generally, as a “Modified Object.”

One benefit provided by the present application is that users are provided a platform and user interface that handles complex processing in response to actions taken by the user that cause one or more transformations to take place. Users can focus on creative steps, such as applying paint or sound to an object, and the present application processes such steps to transform the object accordingly. In one or more implementations, processes happen automatically and changes are saved, and thereafter stored in one or more servers that may be remotely located. In one or more implementations, processing occurs “locally” and within an internet web browser software application. Alternatively, processing occurs on a computing device that is remotely located from the user's computing device. In either instance, processing operations appear seamless to the user.

By providing a platform and user interface in accordance with the teachings herein, users are afforded a creative outlet that produces art and content that can be offered for sale. In one or more implementations, a marketplace is provided in one or more platforms in which artists and creators of Modified Objects may buy and sell works. Modified Objects have value in a similar way as mechanically reproducible art pieces, and the present application supports the creation, selling, modification and (re)selling of such objects. In one or more implementations, libraries of objects and Modified Objects are provided in public and/or private contexts that enable users to contribute to and use.

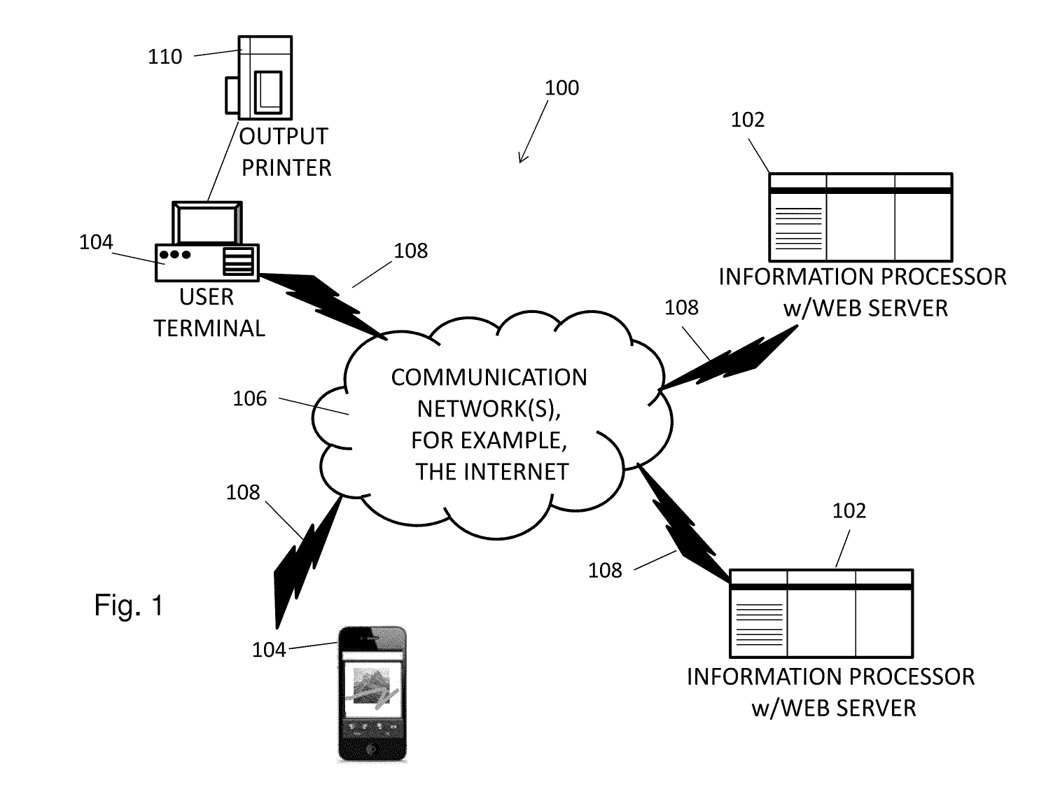

Referring now to the drawings figures in which like reference numerals refer to like elements, there is shown in FIG. 1 a diagram of an example hardware arrangement that operates for providing the systems and methods disclosed herein, and designated generally as system 100. System 100 is preferably comprised of one or more information processors 102 coupled to one or more user workstations 104 across communication network 106.

Continuing with reference to FIG. 1, user workstations may include, for example, mobile computing devices such as tablet computing devices, smartphones, personal digital assistants or the like. Further, printed output is provided, for example, via output printers 110.

Information processor 102 preferably includes all necessary databases for the present invention, including image files, metadata and other information. However, it is contemplated that information processor 102 can access any required databases via communication network 106 or any other communication network to which information processor 102 has access. Information processor 102 can communicate devices comprising databases using any known communication method, including a direct serial, parallel, USB interface, or via a local or wide area network.

User workstations 104 communicate with information processors 102 using data connections 108, which are respectively coupled to communication network 106. Communication network 106 can be any communication network, but is typically the Internet or some other global computer network. Data connections 108 can be any known arrangement for accessing communication network 106, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User workstations 104 preferably have the ability to send and receive data across communication network 106, and are equipped with web browsers to display the received data on display devices incorporated therewith. By way of example, user workstation 104 may be personal computers such as Intel Pentium-class computers or Apple Macintosh computers, but are not limited to such computers. Other workstations which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 106. Of course, one skilled in the art will recognize that wireless devices can communicate with information processors 102 using wireless data communication connections (e.g., WI-FI).

According to an embodiment of the present application, user workstation 104 provides user access to information processor 102. The specific functionality provided by system 100, and in particular information processors 102, is described in detail below.

System 100 preferably includes software that provides functionality described in greater detail herein, and preferably resides on one or more information processors 102 and/or user workstations 104. One of the functions performed by information processor 102 is that of operating as a web server and/or a web site host. Information processors 102 typically communicate with communication network 106 across a permanent i.e., unswitched data connection 108. Permanent connectivity ensures that access to information processors 102 is always available.

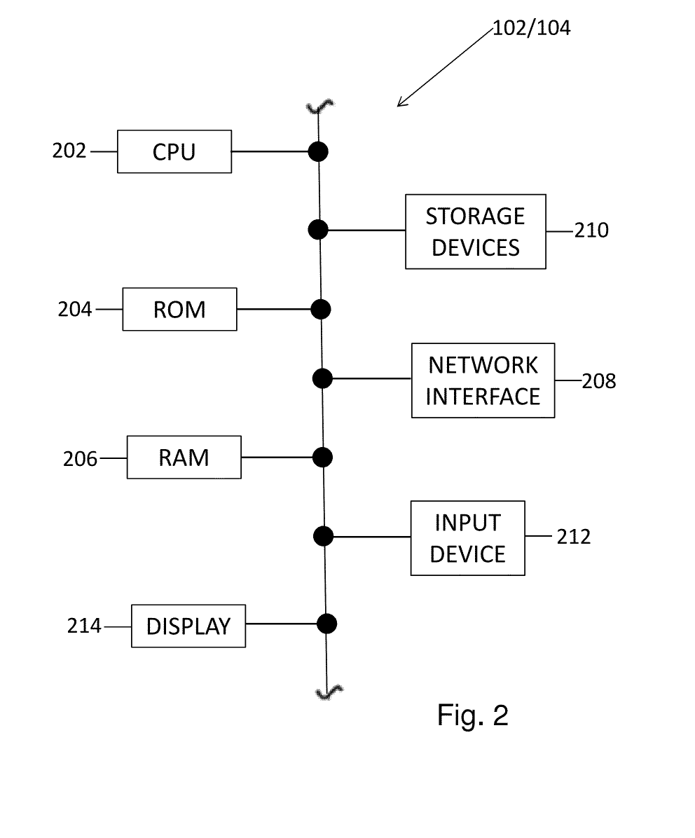

As shown in FIG. 2 the functional elements of information processor 102 and/or workstation 104, and preferably include one or more central processing units (CPU) 202 used to execute software code in order to control the operation of information processor 102, read only memory (ROM) 204, random access memory (RAM) 206, one or more network interfaces 208 to transmit and receive data to and from other computing devices across a communication network, storage devices 210 such as a hard disk drive, floppy disk drive, tape drive, CD-ROM or DVD drive for storing program code, databases and application code, one or more input devices 212 such as a keyboard, mouse, track ball and the like, and a display 214.

The various components of information processor 102 need not be physically contained within the same chassis or even located in a single location. For example, as explained above with respect to databases which can reside on storage device 210, storage device 210 may be located at a site which is remote from the remaining elements of information processors 102, and may even be connected to CPU 202 across communication network 106 via network interface 208.

The functional elements shown in FIG. 2 (designated by reference numbers 202-214) are preferably the same categories of functional elements preferably present in user workstation 104. However, not all elements need be present, for example, storage devices in the case of PDAs, and the capacities of the various elements are arranged to accommodate expected user demand. For example, CPU 202 in user workstation 104 may be of a smaller capacity than CPU 202 as present in information processor 102. Similarly, it is likely that information processor 102 will include storage devices 210 of a much higher capacity than storage devices 210 present in workstation 104. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, IOS, ANDROID, TORR, Ruby, Python, Ruby on Rails, SAAS and PHP and various web application development environments.

As used herein, references to displaying data on user workstation 104 refer to the process of communicating data to the workstation across communication network 106 and processing the data such that the data can be viewed on the user workstation 104 display 214 using a web browser or the like. The display screens on user workstation 104 present areas within system 100 such that a user can proceed from area to area within the system 100 by selecting a desired link, Therefore, each user's experience with system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of system 100.

Although the present application is described by way of example herein in terms of a web-based system using web browsers and a web site server (information processor 102), and with mobile computing devices (104) system 100 is not limited to that particular configuration. It is contemplated that system 100 can be arranged such that user workstation 104 can communicate with, and display data received from, information processor 102 using any known communication and display method, for example, using a non-Internet browser Windows viewer coupled with a local area network protocol such as the Internetwork Packet Exchange (IPX). It is further contemplated that any suitable operating system can be used on user workstation 104, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, WINDOWS 8, MAC OS, LINUX, IOS, ANDROID and any suitable PDA or palm computer operating system.

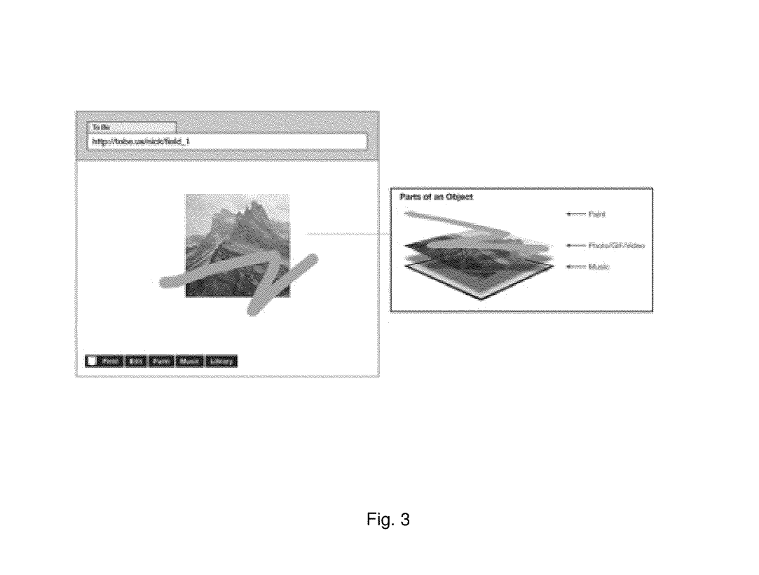

FIG. 3 is an example display screen that illustrates components associated with a Modified Object. Components shown in FIG. 3 include painting, photo/video and music. Furthermore, selections are available for Field, Edit, Paint, Music and Library, which provide corresponding functionality therefor.

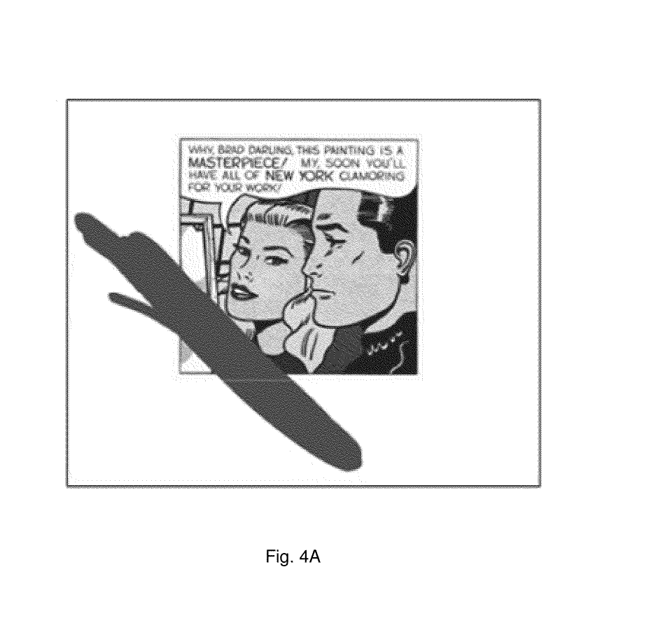

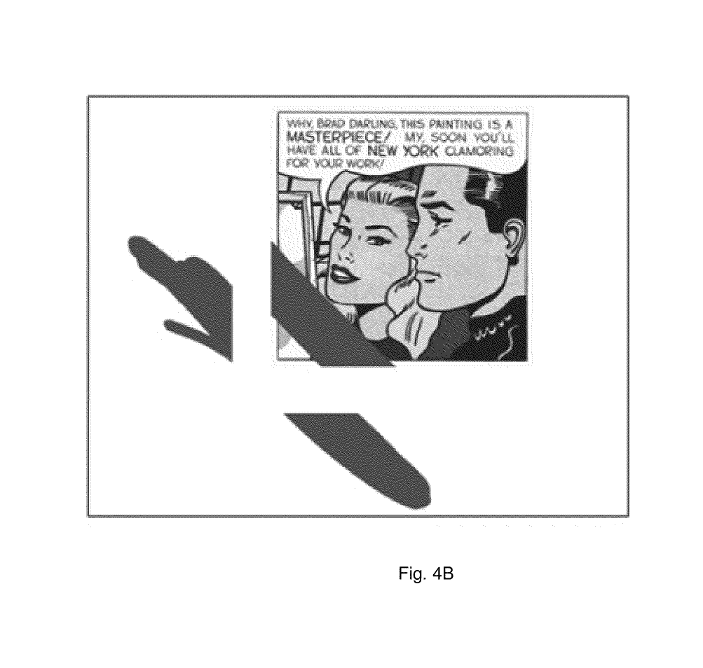

FIGS. 4A and 4B are example implementations illustrating how paint sticks to objects. Please note that the same applies when painting over other objects, including still images and/or video. In FIG. 4A, an image has been added, which is a portion of a comic strip, to a Field and painted using brush on top of it. In FIG. 4B, the painting object is moved away and as can be seen, the object is modified and retains the paint applied on to it.

### The Omniobject

Another innovative aspect of the present application is the Omniobject, which represents the dynamic nature of objects and in which changes to one copy of an object affects other copies of the object in one or more Fields. A discussion regarding the features and functionality associated with Omniobjects is provided below:

(i) User A creates a Modified Object that is in one Field; (ii) User B acquires, collects or copies such Modified Object and ports it to place on another Field, (iii) additional users create additional copies of such Modified Object and port the respective copies to other spaces, without limitation, (iv) User A makes a subsequent amendment to the Modified Object, e.g. by painting additional layers of drawing, changing the sound, the link, the underlying image, or the like, and all of the copies created and ported to other Fields dynamically update. This is made possible as each of the copies of the Modified Object is a true representation of the then current state of the Modified Object created by User A. In one or more implementations, Fields are kept alive, where Modified Objects will be live and updated as constantly as the creator of such Modified Objects so decides.

Continuing with reference to the example set forth above, in case a Modified Object (or a collection of Modified Objects) is acquired by User B, for example, as art or collectable pieces, the present application allows for the creator of such Modified Object(s) to offer on-going alteration(s) of the Modified Objects. In this implementation, the acquirer or collector has a living piece, and one that is not unchanging or static in any form. Instead, users acquire a Modified Object that is capable of change over-time by the original author. The platform offers creators the possibility to be remunerated on a single on-off payment or in the form of a subscription for a periodical and repetitive set amount as the parties may agree. The same or similar principles and forms of transaction can apply to a whole Field, mutatis mutandis, when offered as a one-piece.

### Screenprinting

The present application provides a quasi-physical behavior of paint. In one or more implementations, digital screen-printing or stenciling functionality is provided. An object (e.g., image file) that is added to a Field can be converted into a stencil. In accordance with a user interface, a user simply selects a graphical screen control, such as a button, and certain areas of the object become transparent. The bitmap paint, thereafter, prints through the object on to the background canvas (or onto another object). Similar way as a screen printing or stenciling in the physical world, once a user paints on top of the converted object, the sections of the digital object that have become transparent are printed on the canvas surface.

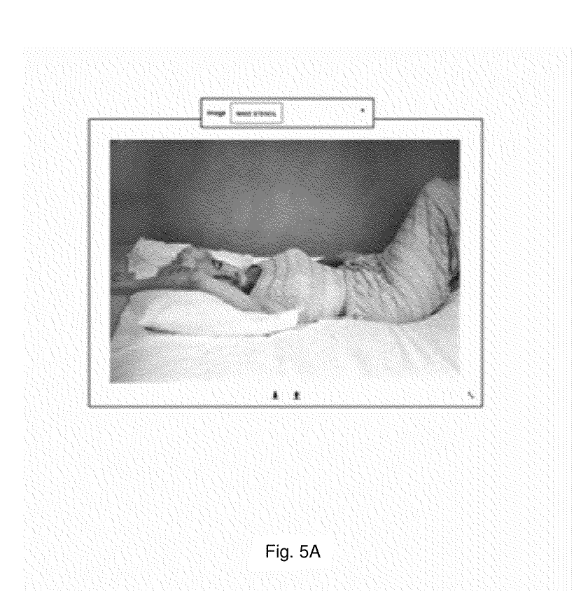

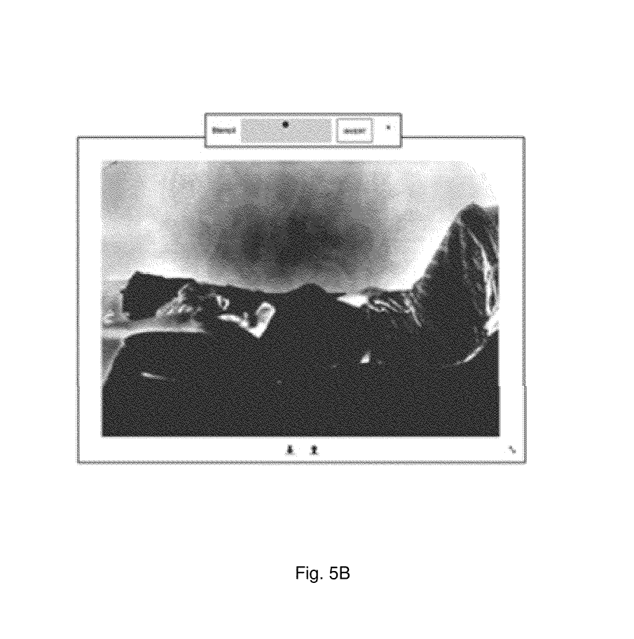

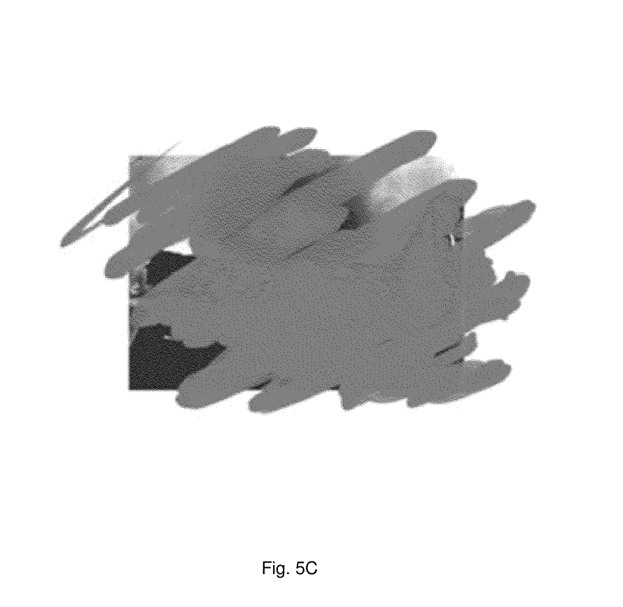

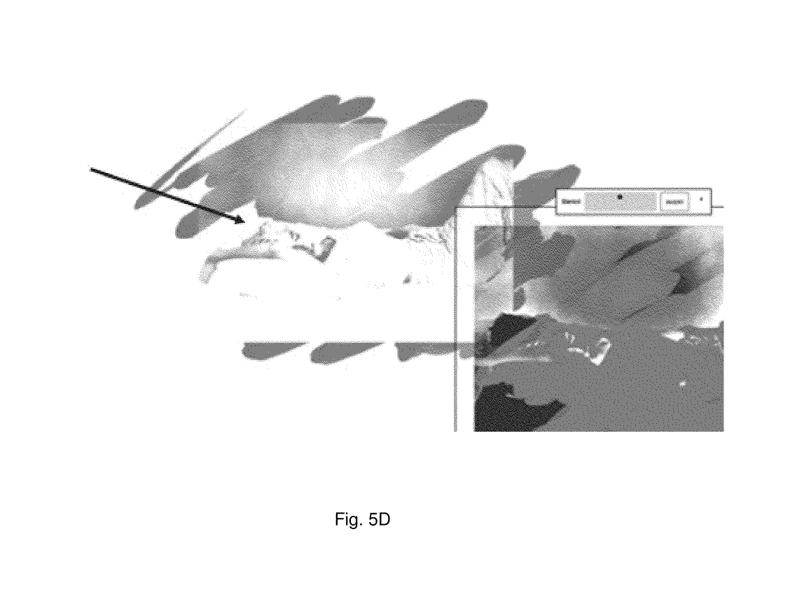

FIGS. 5A-5D illustrate an example screen printing process. In FIG. 5A (step 1), an image is placed in the canvas. In FIG. 5B (step 2), the user has selected make stencil button, which instructed information processor 102 or workstation 104 to transform the image into a stencil. In FIG. 5C, (step 3), the user uses a painting tool to paint over the stencil, and in FIG. 5D (step 4), the stencil is then removed by the user and the resulting image is printed on the background canvas.

In one or more implementations, the user has the ability to select respective highlight and/or greyscale levels associated with the stencil, thereby controlling particular areas to become more transparent, and respective greyscale and contrast values. Once again, the user does not need to do start any additional procedure or rendering. The result is instantaneous, immediate and happens seamlessly for the user, whereby the resulting image is saved and stored in our servers.

In one or more implementations, the process described in connection with FIGS. 5A-5D occurs in the browser directly and under one unique URL. In this way, the user is effectively building content that can be viewable from any the browser by directing the browser to the one unique URL.

### Field Duplication

In one or more implementations, Fields can be duplicated, thereby allowing other users to edit the duplicate resulting Field without altering the original. This feature is referred to herein, generally, as a “Pull.” Creators of a Field can designate any Fields as “pullable” or not. For example, a boolean flag may be set in the database to represent whether a Field should be designated as pullable. If a flag is pullable, a button (or other graphical control) labeled “Pull” may appear in the sidebar under the Field. When the user selects the button, a “create Field” API call can be sent to the backend, with the ID of the original Field sent as a parameter.

In one or more implementations, when the server receives the create Field API call, the server performs the following steps to make a copy of the Field.

1) Make a new row in the Field database table with all the same values as the original Field. Further certain specific attributes are ignored, such as likes for the old Field, and the public/private attributes. In one or more implementations, pulled Fields start out as public. Thereafter, the Field elements which are associated with the Field are duplicated. These can include images, videos, sound files, and paint layers. The copied and original Field element objects both use the same GOOGLE Cloud Storage (GCS) URL, which precludes a waste of space on GCS of duplicate objects.

2) Duplicate all the Field snapshots, which can also be objects stored in the database that reference an image URL on GCS. This is useful for a user to immediately see a thumbnail or snapshot for the new Field.

3) Give the user edit permissions on the new Field by adding a new entry to a table (e.g., labeled “FieldUser”) referencing the user and the new Field.

4) Set an active User Id flag on the new Field to the user's id. This results in the front-end to allow the user to edit the Field right away.

5) Respond to the request with the JSON object representing the new Field. The Ember front end then loads this Field and the user can start editing it right away.

### Field Merge

In one or more implementations, users can merge the Fields in which they participate with other Fields. The result will be a larger Field. This will be the only way to enlarge the surface of the work area. The result is a quilt-like formation of Fields.

### Printing

In one or more implementations, users print work done on the Fields in customized ways. Printing is provided, among other media, for paper (e.g., posters) and for fabric (e.g., t-shirts). Each user is provided options to print respective work the user created, as well as work done on third parties' Fields, provided third parties provide permission. For example, third parties may license or otherwise charge for content in Fields to be distributed and/or printed.

Printing operations in connection with the present application can include at least the following two distinct phases.

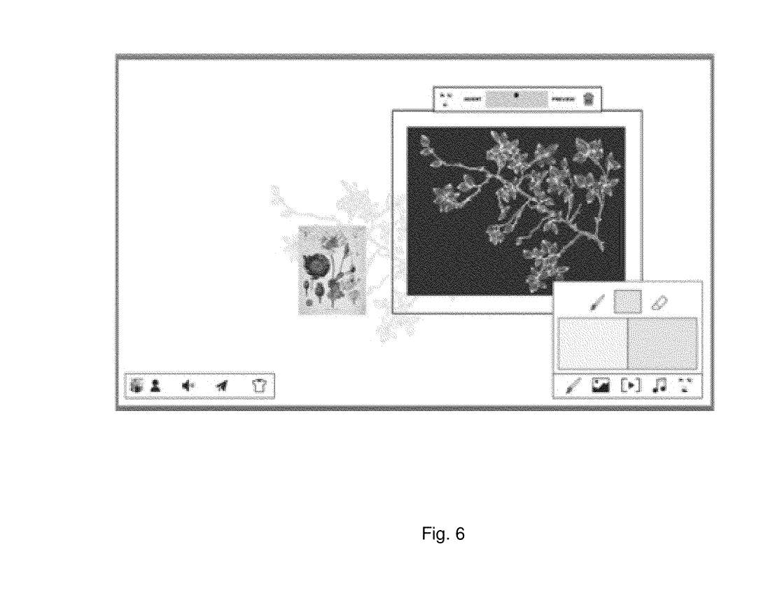

1. The user freely makes work on a Field. FIG. 6 illustrates an example display screen in which a user has converted an image into a screenprint and has painted through it with the painting tool.

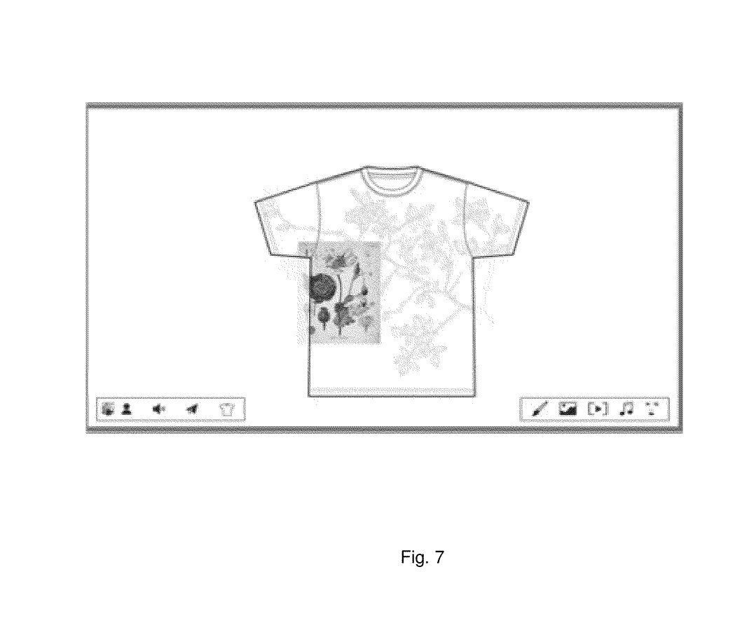

2. The user activates the print button (formatted in FIG. 6 as a t-shirt icon) and the system creates an overlay on top of the Field showing the perimeter of the printable surface (t-shirt), either be it a rectangle for poster prints or a t-shirt shaped figure. FIG. 7 illustrates an example printable surface for printing. As shown in FIG. 7, the user has chosen the t-shirt, and a mask-like object is provided that user moves around the display to frames a particular section of the t-shirt. In this way, the system provides a mask and allows the user to move the image to best fit his/her printing specifications. This allows the user to frame or crop the section (s)he is working on. Moreover, the mask may provide parameters showing the overlay. In one or more implementations, the mask identifies predefined portions in which the image cannot be placed, to prevent impossible printing. For example, the flower image may not be placed over the back of the collar (where the tag is located).

While the overlaid is on top of the Field, the user can continue to work on the Field (inside or outside of the printing perimeter), whereby (s)he might continue applying paint or adding additional images. Once the user considers the work to be finalized, a prompt can be provided for the user to confirm the choice to print and proceed to check-out through an e-commerce application. In the checkout screen, the user may be prompted for shipping address and credit card info. In one or more implementations, the credit card information is validated, such as by a third-party provider (e.g., STRIPE). Once validated, a row is created in the “orders” database table with a link for the transaction (orders.vendor_order_uuid). An email message may be sent to the user with a preview of what was purchased.

In one or more implementations, when a user is ready to print content provided in accordance with the present application, an image (e.g., a “screen-shot”) is created that is placed into the shopping cart. Information provided in connection with the image may include coordinate information or other information to assist with production, such as to identify where cuts need to go, or where printing needs to take place. In addition to payment information, one or more high-resolution image may be transmitted and received, such as of a t-shirt and flower (FIG. 7). Once money is received, the product (e.g., t-shirt) is produced. This may occur by one or more contracted parties (e.g., specialized printing company), or may occur “in-house.” Moreover, individual orders may be provided, or a batch of orders may be provided to a printer.

After the product order is received and confirmed to be accurate, an order confirmation may be sent to a client. When the product is shipped, a notification that the order is fulfilled may be sent to the customer, as well as the tracking number of the shipment.

One technical feature provided by the present application is that any user can see the work done by another user substantially in real time. For example, the printing button (FIG. 7) is active, and while user A is working on its Field, user B can observe the work and decide at any given moment to make a print out of the work while it is in progress. Thus, the present application supports variations for printing your own work and/or printing others' work. Even though the Field content may be the same, each printed work may be different and customized, for example, due to different framing, location of printing objects, or the like.

In one or more implementations, the present application provides a “flattened” rasterized image that is usable for preparing the printed product. For example, when the user decides to save or execute the print, the Field is used to prepare a flat canvas element. The canvas may then be upload to GCS, yielding a png url, which is used to create a FieldMask object. The FieldMask object may contain information about where the user's screen was in the Field. For example, X, Y and Zoom coordinates may be provided.

Further, printer and printing variabilities can be identified, and the flattened image may be adjusted to account therefor. In an alternative implementation, “raw” data may be transmitted to a printer for implementing the printing process. In yet another implementation, a printer has access, such as via an API, to a database that includes the respective print jobs ordered by customers, In such case, any modifications, such as to flatten the image and/or adjust for printing variabilities, may happen independently by the printer. In yet another alternative implementation, printing occurs on fabric, and then a shirt (or other form that is ordered) is assembled, thereafter. In one or more implementations, users can create unique pieces as a function of the flexibility provided by the present application, including by moving a mask object and by implementing cropping options, which allow for nearly infinite combinations of images on products (e.g., t-shirts).

Another feature provided by the present application includes a social e-commerce network, that may include famous graphic personnel. For example, the celebrity Justin Bieber uploads artistic content, which is made available via Field or Omniobject. Justin Bieber charges license fees to anyone who desires to use the artwork , for example $35, provided no artistic changes are made. If a user wishes to change the artwork, for example by using the paint tool, screenprint or other way, then the license fee is $100. Thus, a third party sets license pricing. In one or more embodiments, as users check-out, the appropriate pricing is applied.

In yet other implementations, users pay a proprietor of the present application to include artwork in one or more Fields. Users may pay for the ability to have works distributed, advertised or the like.

### Undo

It is recognized that the present application provides substantial creative options for users. Accordingly, an ability to undo recent actions is provided. For example, when a user changes the Field by painting, erasing, adding/removing objects, or changing objects, the Field state is recorded, by making a copy of each element on the Field. The Field state is stored in an undo stack._When the user presses undo, the previous Field state is restored, for example, by looking in the undo stack for the previous state, and swapping all the current Field elements for the previous version. Prior to swapping the information, the Field state is pushed to a redo stack to be used in the event that the user presses redo.

### Keyboard

Some keyboard shortcuts change the way elements of hardware in a laptop computing device behave. Pressing D plus using the trackpad, for example, makes the trackpad behave as an external tablet controller, such as provided by WACOM. The trackpad of the laptop then can be used to paint without having to click and hold on such trackpad, which makes it significantly easier to use.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

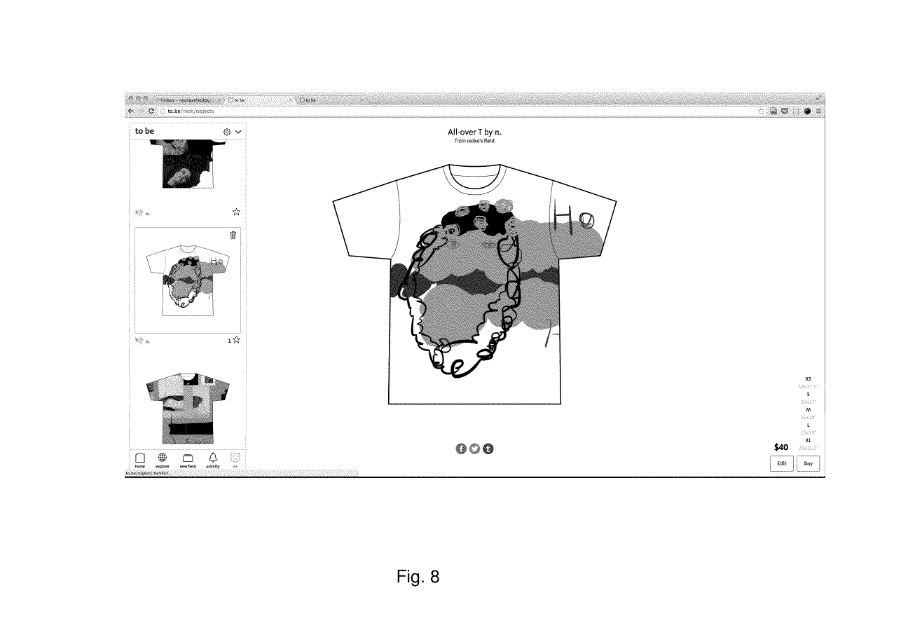

Accordingly, as shown and described herein, the present application supports creating, distributing, reviewing, purchasing and outputting digital art. FIG. 8, for example, illustrates an example use of the present application in which a user creates an art object, including by saving a t-shirt or other design from one of the user's fields for outputting respective digital art.

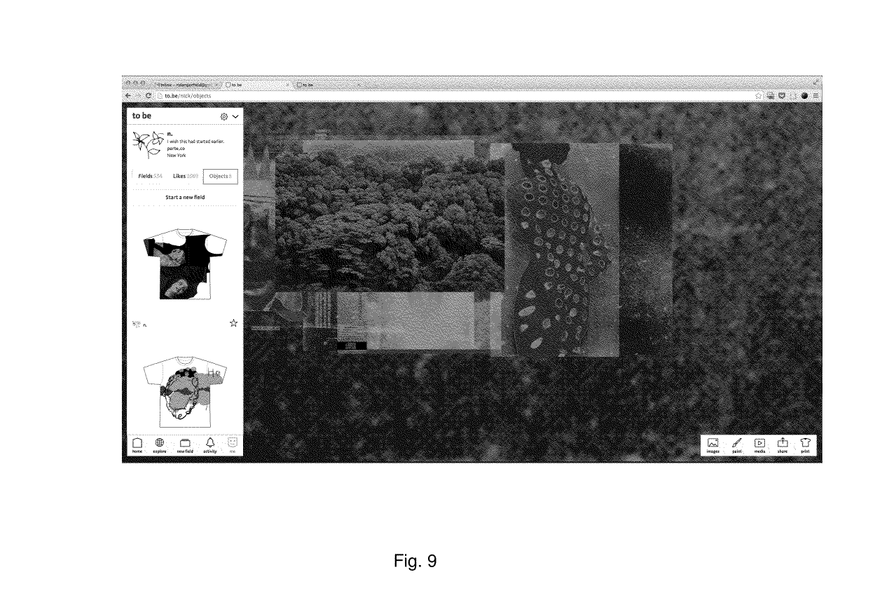

FIG. 9 illustrates an example implementation of the present application in which the art object that has been created is displayed in the user profile. In the example shown in FIG. 9, the digital art is illustrated in an “objects tab” provided in the interface.

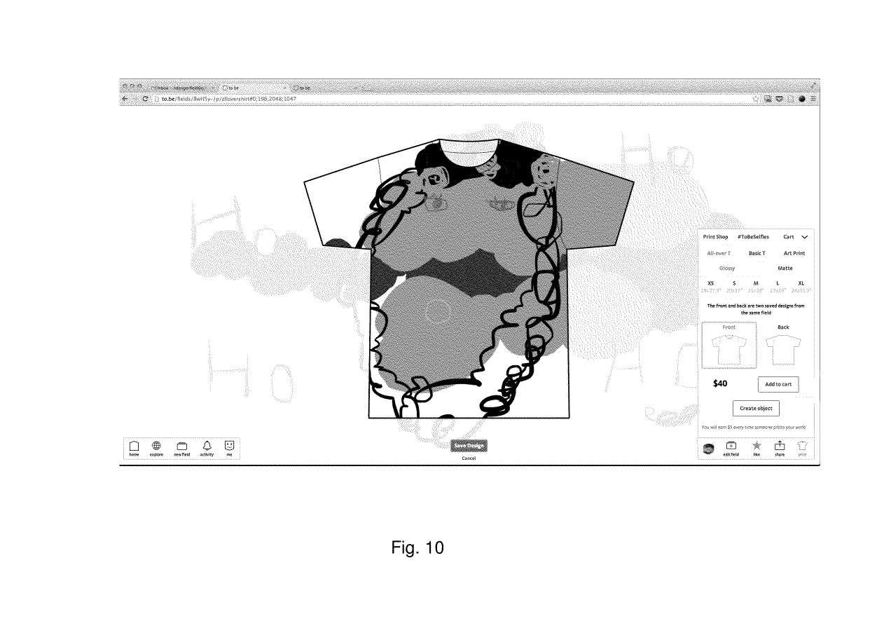

In accordance with the present application, users can select an art object, such as by clicking on an object to access a web page that shows the object in a larger (e.g., full-screen) view. Additionally, various graphical screen controls may be provided, such as a size selector and “buy” button. In an example implementation, after a user selects “buy,” the user is presented with a shopping cart, and can complete purchase using suitable e-commerce functionality, as known in the art. FIG. 10 illustrates an example display screen for e-commerce functionality in accordance with an example implementation of the present application.

Thus, as shown and described herein, the present application supports tremendous flexibility and functionality in connection with digital art creation, modification, distribution and production. In view of the structure, functions and features of the systems and methods of the network described herein, the present solution provides a dynamic, efficient and more accurate way to compute, obtain, store and distribute an estimate of the influence, value and spending ability of an entity in a network of entities. Having described certain embodiments of methods and systems for setting up such a network, it will now become apparent to one of skill in the art that other embodiments incorporating the concepts of the disclosure may be used. Therefore, the disclosure should not be limited to certain embodiments described herein.

What is claimed:

1. A system for providing a digital art platform, comprising,
at least one data structure configured for storing, on processor readable media that is accessible by at least one processor, information associated with digital art, wherein the information includes at least one element associated with the digital art;
a graphical user interface that is operable on each of a plurality of client computing devices, and configured to provide a virtual canvas, wherein the canvas is configured to provide the digital art on each of the plurality of client computing devices;
a transformation module that is configured to receive at least one instruction, from at least one first of the client devices operating the graphical user interface, and to modify the digital art when executed by at least one processor in response to the at least one instruction;
an update module that is configured to transmit, over a data communication network, at least one instruction to at least one second of the plurality of computing devices, wherein the modified digital art is provided in each respective canvas of the at least one second of the plurality of computing devices in response to the at least one instruction; and
an output module that is configured to receive, using the at least one processor, at least one output instruction from at least one of the plurality of computing devices to output the modified digital art in a physical form, and further configured to output, in response to the at least one output instruction, the modified digital art in the physical form.

2. The system of claim 1, wherein the user interface includes a plurality of tools to modify the digital art.

3. The system of claim 2, wherein the digital art is modifiable by adding, removing and changing at least one of: audio, at least one still image, and moving images.

4. The system of claim 1, wherein the at least one data structure includes a document object model.

5. The system of claim 1, wherein the transformation module is configured to convert at least part of an image to a stencil and to enable a user to paint virtually over the stencil.

6. The system of claim 1, wherein the at least one data structure is further configured to store information associated with metadata, field snapshots, user permissions, active user ID flag and responses to information requests.

7. The system of claim 1, wherein the at least one data structure is configured to store versions of the digital art.

8. The system of claim 7, wherein the output module is configured, in response to receiving instructions from a plurality of computing devices, to output various versions of the digital art.

9. The system of claim 1, wherein the at least one data structure stores template information for outputting digital art in accordance with each of a plurality of respective templates.

10. The system of claim 9, wherein at least one of the respective templates is associated with clothing.

11. The system of claim 9, wherein the output module is further configured to generate an instruction, using the at least one processor, for outputting the digital art in accordance with at least one of the respective templates.

12. A method for providing a digital art platform, comprising,
accessing, by at least one processor, at least one data structure that is configured for storing, on processor readable media, information associated with digital art, wherein the information includes at least one element associated with the digital art;
providing a graphical user interface that is operable on each of a plurality of client computing devices, and configured to provide a virtual canvas, wherein the canvas is configured to provide the digital art on each of the plurality of client computing devices;
receiving, using the at least one processor, at least one instruction from at least one first of the client devices operating the graphical user interface, modifying, using the at least one processor, the digital art in response to the at least one instruction;
transmitting, using the at least one processor and over a data communication network, at least one instruction to at least one second of the plurality of computing devices, wherein the modified digital art is provided in each respective canvas of the at least one second of the plurality of computing devices in response to the at least one instruction; and
receiving, using the at least one processor, at least one output instruction from at least one of the plurality of computing devices to output the modified digital art in a physical form, outputting, using the at least one processor and in response to the at least one output instruction, the modified digital art in the physical form.

13. The method of claim 12, wherein the user interface includes a plurality of tools to modify the digital art.

14. The method of claim 13, wherein the digital art is modifiable by adding, removing and changing at least one of: audio, at least one still image, and moving images.

15. The method of claim 13, wherein the at least one data structure includes a document object model.

16. The method of claim 13, further comprising:
converting, using the at least one processor, at least part of an image to a stencil and to enable a user to paint virtually over the stencil.

17. The method of claim 13, wherein the at least one data structure is further configured to store information associated with metadata, field snapshots, user permissions, active user ID flag and responses to information requests.

18. The method of claim 13, wherein the at least one data structure is configured to store versions of the digital art.

13. The method of claim 18, further comprising:
outputting, using the at least one processor and in response to receiving instructions from a plurality of computing devices, various versions of the digital art.

20. The method of claim 13, wherein the at least one data structure stores template information for outputting digital art in accordance with each of a plurality of respective templates.

21. The method of claim 20, wherein at least one of the respective templates is associated with clothing.

22. The method of claim 20, further comprising:
generating an instruction, using the at least one processor, for outputting the digital art in accordance with at least one of the respective templates.
